(19) United States
(12) Patent Application Publication
(10) Pub. No.: US 2006/0267256 A1
(43) Pub. Date: Nov. 30, 2006

(54) Systems and methods for molding a thermoplastic

(76) Inventor: David O. Martin, Salt Lake City, UT (US)

Correspondence Address: KIRTON AND MCCONKIE, 60 EAST SOUTH TEMPLE,, SUITE 1800, SALT LAKE CITY, UT, 84111, US

(21) Appl. No.: 11/406,935

(22) Filed: Apr. 19, 2006

Related U.S. Application Data
(60) Provisional application No. 60/672,926, filed on Apr. 19, 2005.

(51) Int. Cl. B29C 51/00

(52) U.S. Cl. 264/553; 425/388

(57) ABSTRACT

Systems and methods of molding thermoplastics are disclosed. According to some embodiments of the invention, systems and methods are disclosed for molding a thermoplastic resin using a partially disposed vacuum force. In one embodiment, a precision-molded thermoplastic is created that resembles a window or decorative panel having the appearance of stained glass.

### RELATED APPLICATIONS

This application claims priority to U.S. provisional application Ser. No. 60/672,926, filed Apr. 19, 2005.

### BACKGROUND

Thermoplastics can be molded using a variety of techniques. Thermoplastic resins can be manufactured at low cost, with low weight compared to glass, and with high transparency, rendering them appropriate for many industrial and artistic uses, including as a substitute for stained glass windows.

To create a traditional stained glass window, an artist fashions numerous pieces of colored or clear glass into shapes that, when placed together in a mosaic, will form an image or design. Individual pieces of glass are placed between lengths of grooved strips called cames. Cames are typically made of lead. These lead cames form the borders or outline of the final design. Solder is then added to secure the glass into the lead cames. Though hand-wrought stained glass windows are beautiful, they are too costly and time consuming for use in many circumstances where their aesthetic characteristics would nonetheless be desired. Further, the nature of the glass pieces and lead cames renders stained glass windows fragile and subject to deterioration because of weathering, sagging, and other related problems.

Despite the potential advantages of using a thermoplastic resins as a substitute for traditional stained glass windows, the prior art has been inadequate because it is either unsuitable for high-volume manufacturing because of the manual steps required, or it lacks the precision required to create objects of consistent quality.

### SUMMARY

The present invention relates to systems and methods of molding thermoplastics. According to some embodiments of the invention, systems and methods are disclosed for molding a thermoplastic resin using a partially disposed vacuum force. In one embodiment, a molded thermoplastic is created that resembles a window or decorative panel having the appearance of stained glass.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only embodiments of the present invention and are not, therefore, to be considered as limiting the scope of the invention, the present invention will be described and explained with additional specificity and detail through the use of the accompanying drawings in which:

FIG. 1 illustrates one embodiment of a system based upon the present invention;

FIG. 2 illustrates a cross sectional view of a mold constructed according to one embodiment of the present invention;

FIG. 2A illustrates an edge-on view of a planar thermoplastic object prior to molding using an embodiment of the present invention;

FIG. 2B illustrates an edge-on view of a planar thermoplastic object after molding using an embodiment of the present invention;

FIG. 3 illustrates a top view of a mold constructed according to one embodiment of the present invention;

FIG. 4 illustrates an isometric view of a mold constructed according to one embodiment of the present invention;

FIG. 5 illustrates an embodiment of a method according to one embodiment of the present invention.

### DETAILED DESCRIPTION

The figures listed above are expressly incorporated as part of this detailed description. The presently disclosed embodiments of the invention will be best understood by reference to the drawings, wherein like parts are designated by like numerals throughout.

It will be readily understood that the components of the present invention, as generally described and illustrated in the embodiments discussed herein, could be arranged and designed in a wide variety of different configurations. Thus, the following more detailed description of certain embodiments of the systems and methods of the present invention is not intended to limit the scope of the invention as claimed, but is merely representative of some embodiments of the invention.

While some embodiments have proven to be particularly useful in the area of forming or molding thermoplastic materials to create objects having the appearance of stained glass windows, those skilled in the art can appreciate that the systems and methods disclosed herein may be useful in a variety of different applications and in a variety of different areas of manufacture. Non-limiting examples include all types of decorative panels and window-like surfaces, picture frames, home decor items, as well as industrial shaping of thermoplastics, metals, and a variety of other materials for a variety of non-decorative purposes.

According to some embodiments of the invention, a mold is provided for molding or forming a thermoplastic object placed on or in the mold, where the thermoplastic object may be a substantially rigid thermoplastic object, and where the mold comprises one or more first areas that are in substantially direct contact with the thermoplastic object prior to forming or molding the thermoplastic object, and one or more second areas that are not in direct contact with the thermoplastic object prior to forming or molding the thermoplastic object.

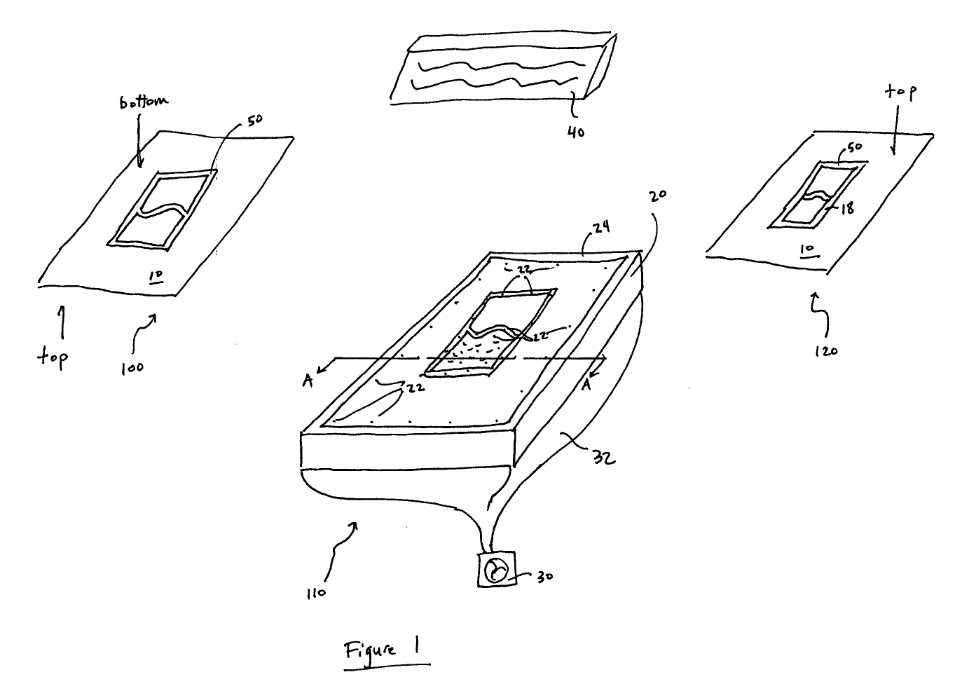

FIG. 1 illustrates one embodiment of a system used to form or mold a thermoplastic object 10 that may be substantially rigid prior to forming or molding. In some aspects, the system comprises a mold 20, a vacuum force 30, and a heat source 40. In one embodiment, the system is used to mold a thermoplastic sheet to form a window, pane, or panel having an appearance resembling stained glass. As disclosed herein, some embodiments permit molding all or part of a thermoplastic object in a highly precise manner, including, without limitation, molding or deforming only a portion of a thermoplastic object and molding a thermoplastic object in a manner that corresponds to a high degree of precision with a design applied to the thermoplastic object.

The material used in one embodiment may be of any suitable thermoplastic resin or other suitable material, including, without limitation, acrylic, polycarbonate, acrylonitrile butadiene styrene (ABS), high impact polystyrene (HIPS), high molecular weight high density polyethylene (HMWPE), polyester terephthalate glycol (PETG), polyvinyl chloride (PVC), thermoplastic olefin (TPO), low density polyethylene (LDPE), crystalline polyester (CPET), semi-crystalline polymers, high density polyethylene, polypropylene, and polyethylene-terephthalate.

In some aspects, the mold 20 is manufactured to correspond to the design or shape desired for a finished thermoplastic that has been molded. Any design or shape may be created. In one embodiment, the mold 20 comprises a space for a substantially planar piece of thermoplastic resembling in some aspects a sheet of glass.

The mold 20 may be formed from any suitable substance using techniques well-known to those skilled in the art. In one embodiment, the mold 20 is formed of a material that does not absorb heat readily, so that when heat is applied to the thermoplastic (as hereinafter discussed), that heat is absorbed principally by the thermoplastic and not by mold 20. In some aspects, the mold 20 has a specific heat that is higher than the specific heat of the thermoplastic to be formed on or within the mold 20. In one embodiment, the mold 20 is formed from a two-part epoxy resin. Many other materials are suitable for use in forming the mold 20, including, but not limited to, urethane, bondo, and wood.

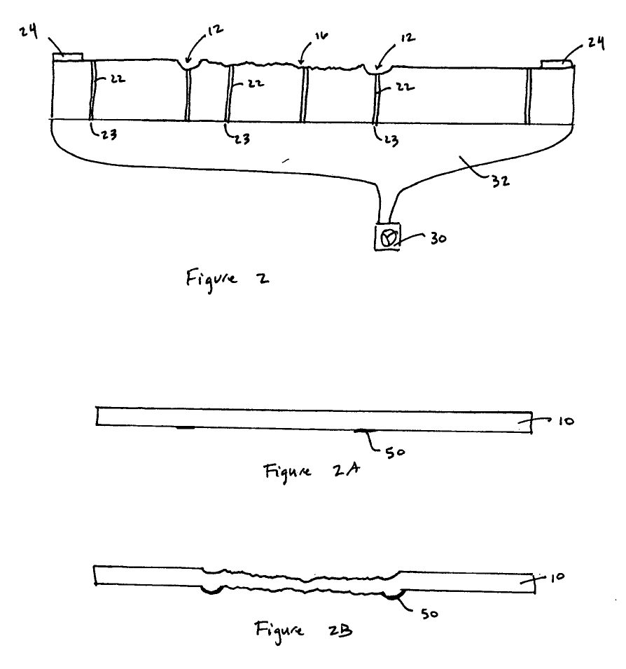

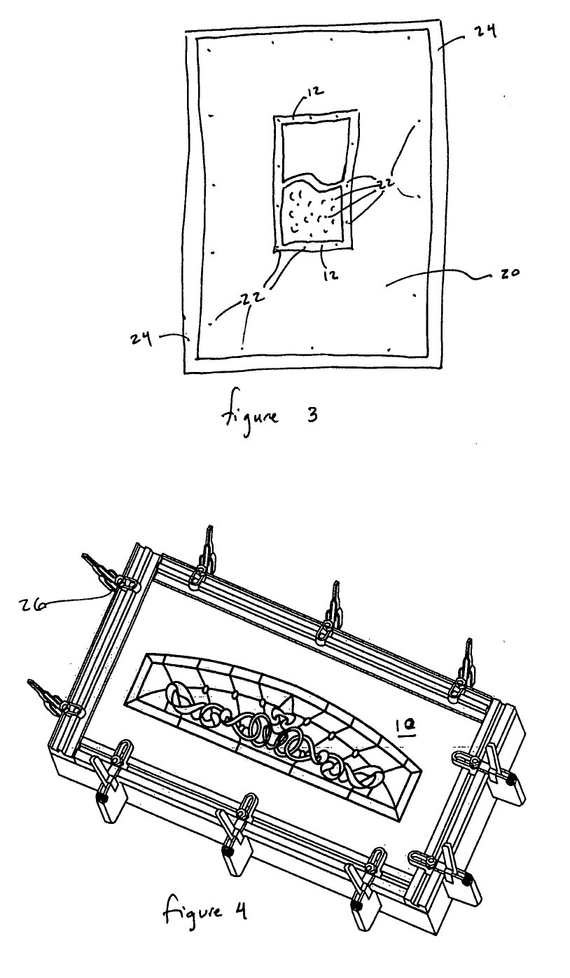

In some embodiments, the mold 20 includes portions contoured to correspond to design features desired in the finished, molded thermoplastic object 10. In an embodiment intended to create a thermoplastic sheet resembling stained glass, portions of the mold 20 may include depressions or voids 12, as seen in cross section A shown in FIG. 2, intended to mimic the lead cames of traditional stained glass; beveled or sloping portions intended to create the appearance of beveled glass; bumpy or irregular areas 16 intended to mimic a texture, such as rippled glass, obscure glass, pebbled glass; scalloped glass, or any other regular or irregular pattern or appearance as is known in the art; and other features that may be created by those skilled in the art. A top view of one exemplary mold 20 is illustrated in FIG. 3.

In some aspects, the mold 20 is further constructed to interact with the vacuum force 30 discussed hereinafter, such that the vacuum force 30 can be applied to a thermoplastic object placed in or on the mold 20. In one embodiment, numerous apertures, or vacuum apertures 22, are formed in the mold 20 through which the vacuum force 30 acts upon a thermoplastic object 10 placed in or on the mold 20. In some embodiments of the invention, the vacuum apertures 22 are open to the portion of the mold whereon the thermoplastic object 10 is placed and extend substantially through the mold 20 to where a distal end 23 of the vacuum aperture 22 opens to a vacuum chamber 32 through which the vacuum force 30 operates. In some embodiments, the distal end 23 of the vacuum aperture 22 may be connected to a tube or similar structure through which the vacuum force 30 operates. In some embodiments, each vacuum aperture 22 has a diameter of between approximately 1/32^{nd} and ⅛^{th} inch.

In one embodiment in which a mold 20 is used to form a thermoplastic object 10 to resemble a stained glass window, vacuum apertures 22 are positioned in the mold 20 to correspond to the design features that create the appearance of stained glass. For example, vacuum apertures 22 may be placed within mold 20 to create features intended to resemble lead cames, or within mold features intended to resemble beveled glass. In other embodiments, vacuum apertures may correspond to mold features representing design elements of a stained glass window, such as beveling, pebbling, or rippling.

In some embodiments, vacuum apertures 22 are also placed around the perimeter of the mold 20 in a manner that the vacuum force 30 can hold a thermoplastic object 10 placed within the mold 20 in a secure position during use of the system.

The number of vacuum apertures 22, the position of each vacuum aperture 22 within the mold 20, and the diameter or other size and shape characteristics of each vacuum aperture 22 may be selected by one skilled in the art according to the specific requirements of the mold 20, the design chosen, and the desired final result for the shape, appearance, and characteristics of the thermoplastic object 10 to be molded thereby.

In one embodiment, the mold 20 further comprises gaskets 24 and edge clamps 26 (see FIG. 4) positioned so as to releasably engage the perimeter of a thermoplastic object placed in or on the mold 20. Gaskets 24 serve to facilitate a secure vacuum seal between the mold 20 and the thermoplastic object 10 to be molded, as hereinafter discussed. Gaskets 24 may be formed using any suitable material, including, but not limited to, silicone, urethane, and rubber. In one embodiment, edge clamps 26 are also used to stabilize the position of the thermoplastic object 10 during molding. In an embodiment designed to create a thermoplastic object resembling a stained glass window, edge clamps 26 press against a thermoplastic sheet after it is placed into the mold 20; edge clamps 26 in this embodiment are designed so as to impinge minimally on the edge of the thermoplastic sheet, so as to not interfere with heating of the thermoplastic, as hereinafter discussed. Edge clamps 26 may be made of any suitable substance, including a variety of metals, ceramics, composites, or other materials as needed for the environment in which the mold 20 is used.

In one embodiment, edge clamps 26 are formed of aluminum and, when positioned against a substantially planar piece of thermoplastic, the edge clamps 26 engage the thermoplastic by approximately one-eighth inch along substantially the entire perimeter of the planar piece of thermoplastic. The use of aluminum for edge clamps 26 facilitates heat transfer to the thermoplastic at its edges, in order to prevent uneven heating of the thermoplastic, as hereinafter discussed.

In one embodiment, a small amount of high-temperature silicone spray is applied to the mold 20 before the thermoplastic object 10 is placed in or on the mold 20. The silicone spray inhibits scratching of the surface of the thermoplastic object 10 and may fill minor surface imperfections during the molding process, thus creating a higher quality finish on the completed piece.

As heretofore mentioned, the mold 20 comprises apertures, or vacuum apertures 22, through which a vacuum force 30 is applied. The vacuum force 30 may be applied via the vacuum apertures 22 by means of tubing connected to the distal end 23 of each vacuum aperture 22, a vacuum chamber 32 located opposite the intended position of the thermoplastic object 10, or otherwise, as is known in the art.

The amount of vacuum force 30 applied to mold a thermoplastic object 10 varies based upon the characteristics of the mold 20, the characteristics of the thermoplastic chosen, the characteristics of the desired finished object after molding, and other factors as are known in the art. In some aspects, the amount of vacuum force 30 may be varied over time, so long as the amount of vacuum force 30 does not exceed the amount needed to form or distort the thermoplastic object 10 beyond what is desired.

The vacuum force 30 may be created or provided by any mechanical, electrical, or other means known in the art.

A heat source 40 placed substantially adjacent to the thermoplastic object 10 when placed within the mold 20 facilitates the molding of the thermoplastic object 10. The heating source 40 may be of any type known in the art, including infrared lamps, electrical resistance element heaters, butane torches, or otherwise. In some aspects, the temperature and uniformity of the heat source 40 affect the quality or other characteristics of the resulting molded thermoplastic object 10; the speed of the molding process; the cost of the molding process; and other factors.

The appropriate temperature of the heat source 40 and the length of time that the heat source is activated will vary based on factors such as, but not limited to, the complexity of the shape to be molded, the specific thermoplastic substance to be molded, the thickness or other shape characteristics of the thermoplastic object prior to molding, the specific heat of the materials used to construct the mold and its components, and other factors.

In one embodiment, a heating source 40 is activated only after the vacuum force 30 has been activated.

According to some embodiments of the invention, the heating source 40 is activated at a temperature and for a length of time to soften the thermoplastic object only sufficiently that those portions of the thermoplastic object 10, (a) to which a vacuum force is directly applied; and (b) which are not in substantially direct contact with the mold 20 are molded, formed, or altered in shape. Other portions of the thermoplastic object 10, though subject to the heat source, remain substantially immobile and unchanged during any forming or molding operation because they are either (1) not directly subject to the vacuum force 30 because of the positioning of the vacuum apertures 22; or (2) are directly subject to the vacuum force 30 but are already substantially in contact with the mold and so remain substantially unchanged in shape or position. Put in other terms, the areas of the thermoplastic object that are formed or molded by the operation of the embodiment are those areas adjacent to a void 12 or space 16 in the mold 20 into which they are deformed or molded. This is illustrated in FIGS. 2A and 2b, which show, respectively, a cross-sectional view of a planar thermoplastic object 10 before and after molding using an embodiment of the invention.

In one embodiment, the viscosity of the thermoplastic object 10 is altered by the heat source 40 so as to cause or permit only a portion of the thermoplastic object 10 to deform or to be molded, while other areas of the thermoplastic object 10 remain substantially immobile. The shape of the mold 20 and the desired features incorporated therein determine which areas of the thermoplastic object 10 are deformed and which remain unaffected.

In some aspects, the heat source 40 is deactivated and the thermoplastic object 10 is permitted to cool to a rigid or semi-rigid state before being removed from the mold 20. In one embodiment, the thermoplastic object 10 is air-cooled so as to prevent warping that may result from uneven or overly rapid cooling. In this regard, a mold 20 that utilizes edge clamps 26 may reduce shrinkage of the thermoplastic object 10 by holding it in place during cooling.

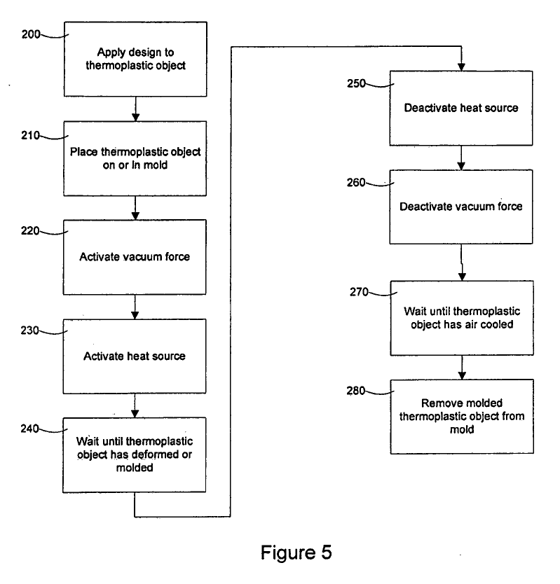

According to some embodiments of the invention, a method of molding a thermoplastic may generally comprise the steps shown in FIG. 5.

In one embodiment, prior to or contemporaneously with placing a thermoplastic object 10 on or in the mold 20, a design may be placed on or in the thermoplastic object 10 at step 200.

In an embodiment intended to create a thermoplastic object resembling a stained glass window, a design 50, shown at portion 100 of FIG. 1, may be placed on a substantially planar thermoplastic sheet. The nature of the materials used to create the design is determined by the environment in which the finished piece will be used. For example, if the surface on which the design is placed may be subject to extremes of weather or temperature, different materials will be used compared to uses intended for a less harsh environment.

In one embodiment, silk-screening is used to apply a design 50 to the thermoplastic object 10. This technique, which is well-known in the art, permits rapid and repetitive application of a design 50 and is thus suitable for automated or high-volume manufacturing situations. Multi-stage silk-screening enables the use of designs that include multiple colors or design materials. Though the use of large-scale silk-screen processes might impose restrictions on the types or designs or materials used, such restrictions are not inherent in the present invention. Hand-application of designs using a variety of known techniques is also possible. A formable film may also be used to place a design on the thermoplastic object 10. Other methods of applying a design 50 as are known in the art are also contemplated in this step. The method disclosed herein does not rely upon specific timing or materials requirements during the optional application of a design 50 to the thermoplastic object 10.

In one embodiment, the material that comprises a design 50 includes compounds that increase the resemblance of the finished object to stained glass. For example, metal bits or flakes may be added to inks, paints, or other design materials to create a metallic look on the portion of the design 50 that mimics the lead cames of traditional stained glass. Such metal flakes may also be designed to assume a patina over time to resemble materials such as copper.

In an embodiment intended to create thermoplastic objects that resemble stained glass windows, design elements may be applied to a thermoplastic object 10 in a manner that corresponds to features of the mold 20, as for example, silk-screened black lines placed on a thermoplastic sheet may correspond in position with rounded depressions or voids 12 within the mold 20, such that after molding, the black lines, now rounded by molded, resemble the lead cames of a stained glass window.

At step 210, a thermoplastic object 10 to be molded is placed on or within the mold 20. The material used in one embodiment may be of any suitable thermoplastic resin or other suitable material.

In one embodiment used to form a thermoplastic object resembling a stained glass window, Implex® brand acrylic sheeting from K-mac Plastics is used as the thermoplastic object to be molded. This material generally provides excellent impact resistance and weatherability in outdoor environments.

At step 220, contemporaneously with or after a thermoplastic object 10 to be molded is placed on or within the mold 20, a vacuum force 30 may be applied as previously discussed. In some aspects, the vacuum force 30 holds the thermoplastic object 10 in a substantially fixed position relative to the mold 20. Gaskets 24 or edge clamps 26 that are part of or associated with the mold 20 may further facilitate a secure positioning of the thermoplastic object 10 to be molded.

At step 230, a heating source 40, as previously discussed, may be activated adjacent to the thermoplastic object 10 to be molded.

In one embodiment, the heating source 40 is activated only after the vacuum force 30 has been activated.

In an embodiment designed to create a thermoplastic object 10 resembling a stained glass window, the heating source 40 raises the temperature of a substantially planar thermoplastic object, causing the thermoplastic object 10 to soften, or become less viscous. As the thermoplastic object 10 softens, the vacuum force 30 being applied via vacuum apertures 22 draws a portion of the thermoplastic object 10 into voids 12 or depressions 16 formed within the mold 20. Because the thermoplastic object 10 is firmly biased against the mold 20 by the vacuum force 30, any design that was applied to the thermoplastic object, and that corresponds to a feature of the mold 20, will precisely follow the mold 20 as the softened thermoplastic object 10 is drawn into the voids 12 or depressions 16 of the mold 20, such as rounded depressions that mimic lead cames, as well as larger areas in the mold intended to resemble other features such as beveled glass or texturing of various types. Only the portions of the thermoplastic object 10 that lie above depressions or voided areas of the mold 20 are deformed by the vacuum force 30 after the thermoplastic object 10 is softened by the heat source 40. Portions of the thermoplastic object 10 corresponding to portions of the mold 20 in which no voids 12 are formed remain firmly in place, and substantially unchanged in shape.

In some aspects, the heat source 40 is deactivated in step 250 after the waiting step 240, when the thermoplastic object 10 has formed to the contours of the mold 20 to the desired degree. In one embodiment, this may not be a complete forming to the contours of the voids 12 within the mold—that is, the thermoplastic object 10 is not distorted to the point that it touches all parts of the mold 20. Minimal experimentation by those skilled in the art will be necessary for each new mold 20 or design 50 in order to determine the appropriate temperature of the heat source 40 and the activation time needed for the desired result.

After the heat source 40 is deactivated in step 250 and the vacuum force 30 is deactivated in step 260, the thermoplastic object 10, now molded, may be cooled or may be allowed to cool. In one embodiment, shown in step 270, air cooling is used so as to prevent warping of the thermoplastic that may result from uneven or overly rapid cooling. Edge clamps 26 associated with the mold 20 may reduce shrinkage of the thermoplastic object by holding it in place during cooling.

The vacuum force 30 may be deactivated either before, during, or after the thermoplastic object 10 cools, according to the desired characteristics of the finished object. In one embodiment, edge clamps 26 are removed after the thermoplastic object has cooled; the thermoplastic object 10 is then removed from the mold 20 in step 280.

When an embodiment of the present method is used to form a thermoplastic object 10 resembling stained glass, the resulting object exhibits many desirable characteristics. In one embodiment, portions of a thermoplastic sheet to which a design 50 has been applied and which has then been positioned adjacent to rounded depressions or voids 12 in the mold 20 may appear with a relief and a coloration mimicking lead cames in a traditional stained glass window as shown in portion 120 of FIG. 1. Coloration from the design 50 may be apparent on the convex surface 18 of the finished thermoplastic object 10. Optional areas of coloration applied during the design step 200, or areas of clear thermoplastic sheeting, can be formed to resemble pieces of beveled glass or textured glass of many types, as discussed previously.

Other desirable characteristics of the thermoplastic object that were present before molding remain intact. For example, a thermoplastic sheet may retain its flexibility, resiliency, clarity, and weather-resistance.

Numerous specific systems and methods are encompassed within the present invention. The scope of the present invention is therefore indicated by the appended claims, rather than by the foregoing description. All changes which come within the meaning and range of equivalency of the claims are to be embraced within their scope.

What is claimed is:

1. A system for molding a thermoplastic object comprising
a mold comprising at least one first area that is substantially in direct contact with said thermoplastic object, at least one second area that is not in direct contact with said thermoplastic object prior to said molding, and apertures, wherein at least one of said apertures is positioned within said at least one first area and at least one of said apertures is positioned within said at least one second area;
a vacuum force capable of acting through said apertures and disposed to hold said at least one first area substantially immobile; and
a heat source capable of reducing the viscosity of at least a portion of said thermoplastic object.

2. The system of claim 1 wherein said at least one of said apertures positioned within said at least one first area is positioned substantially at the perimeter of said mold.

3. The system of claim 1 wherein said mold comprises a material having a first specific heat and said thermoplastic object comprises a material having a second specific heat that is lower than said first specific heat.

4. The system of claim 1 wherein said thermoplastic object is clamped into said mold.

5. The system of claim 1 wherein said mold further comprises a gasket.

6. The system of claim 1 wherein said thermoplastic object is a substantially planar sheet.

7. The system of claim 1 wherein said thermoplastic object comprises a material selected from the group consisting of acrylic, polycarbonate, acrylonitrile butadiene styrene, high impact polystyrene, high molecular weight high density polyethylene, polyester terephthalate glycol, polyvinyl chloride, thermoplastic olefin, low density polyethylene, crystalline polyester, semi-crystalline polymers, high density polyethylene, polypropylene, and polyethylene-terephthalate.

8. The system of claim 1 wherein said thermoplastic object comprises a design.

9. A method of molding a thermoplastic object comprising:
forming a mold comprising at least one first area that is substantially in direct contact with said thermoplastic object, at least one second area that is not in direct contact with said thermoplastic object prior to said molding, and apertures, wherein at least one of said apertures is positioned within said at least one first area and at least one of said apertures is positioned within said at least one second area;
placing said thermoplastic object in or on said mold;
activating a vacuum force, wherein said vacuum force acts upon said thermoplastic object through said apertures, biasing said thermoplastic object against said mold; and
heating said thermoplastic object so as to decrease a viscosity of at least a portion of said thermoplastic object.

10. The method of claim 9 wherein said at least one of said apertures positioned within said at least one first area is positioned substantially at the perimeter of said mold.

11. The method of claim 9 wherein said mold comprises a material having a first specific heat and said thermoplastic object comprises a material having a second specific heat that is lower than said first specific heat.

12. The method of claim 9 further comprising clamping said thermoplastic object into said mold.

13. The method of claim 9 wherein said mold further comprises a gasket.

14. The method of claim 9 wherein said thermoplastic object comprises a substantially planar sheet.

15. The method of claim 9 wherein said thermoplastic object comprises a material selected from the group consisting of acrylic, polycarbonate, acrylonitrile butadiene styrene, high impact polystyrene, high molecular weight high density polyethylene, polyester terephthalate glycol, polyvinyl chloride, thermoplastic olefin, low density polyethylene, crystalline polyester, semi-crystalline polymers, high density polyethylene, polypropylene, and polyethylene-terephthalate.

16. The method of claim 9 further comprising applying a design to said thermoplastic object.

17. The method of claim 9 wherein said activating step is performed before said heating step.

18. A method of molding a substantially planar thermoplastic object to resemble a stained glass window, comprising
applying a design to said thermoplastic object, said design comprising elements representing lead cames;
forming a mold comprising at least one first area that is substantially in direct contact with said thermoplastic object, at least one second area that is not in direct contact with said thermoplastic object prior to said molding and that substantially corresponds to areas of said thermoplastic object which are to be deformed by said molding, and apertures, wherein at least one of said apertures is positioned within said at least one first area and at least one of said apertures is positioned within said at least one second area;
placing the object on or in the mold;
activating a vacuum force, wherein said vacuum force acts upon said thermoplastic object through said apertures, biasing said thermoplastic object against said mold;
Heating said thermoplastic object so as to decrease a viscosity of at least a portion of said thermoplastic object, and wherein after said decrease of said viscosity, said vacuum force causes said at least one second area to deform in a manner to substantially come in contact with said mold;
cooling said thermoplastic object so as to increase its viscosity; and
removing said thermoplastic object from said mold.

19. The method of claim 18 wherein said at least one of said apertures positioned within said at least one first area is positioned substantially at the perimeter of said mold.

20. The method of claim 18 wherein said mold comprises a material having a first specific heat and said thermoplastic object comprises a material having a second specific heat that is lower than said first specific heat.

21. The method of claim 18 further comprising clamping said thermoplastic object into said mold.

22. The method of claim 18 wherein said mold further comprises a gasket.

23. The method of claim 18 wherein said thermoplastic object comprises a material selected from the group consisting of acrylic, polycarbonate, acrylonitrile butadiene styrene, high impact polystyrene, high molecular weight high density polyethylene, polyester terephthalate glycol, polyvinyl chloride, thermoplastic olefin, low density polyethylene, crystalline polyester, semi-crystalline polymers, high density polyethylene, polypropylene, and polyethylene-terephthalate.

24. The method of claim 18 wherein said activating step is performed before said heating step.
